(19) United States
(12) Patent Application Publication
(10) Pub. No.: US 2012/0169808 A1
(43) Pub. Date: Jul. 5, 2012

(54) INKJET PRINTING METHOD, PRETREATMENT LIQUID FOR INKJET PRINTING AND INK COMPOSITION

(75) Inventors: Hiroshi Kiyomoto, Hiratsuka-shi (JP); Ryoze Akiyama, Mishima-shi (JP); Takaya Kitawaki, Mishima-shi (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/417,699

(22) Filed: Mar. 12, 2012

Related U.S. Application Data
(63) Continuation of application No. 12/388,071, filed on Feb. 18, 2009.
(60) Provisional application No. 61/032,372, filed on Feb. 28, 2008.

(51) Int. Cl. B41J 2/015; B41J 2/01

(52) U.S. Cl. 347/21; 347/101

(57) ABSTRACT

According to an embodiment of the present invention, with an inkjet printer, an image is formed by adhering a colorless pretreatment liquid containing a polyvalent metal salt, 3-methoxy-3-methyl-1-butanol, and water to a plain paper thereby subjecting the plain paper to pretreatment, and thereafter, ejecting at least one type of ink composition containing a pigment and water and reacting with the polyvalent metal salt onto the plain paper.

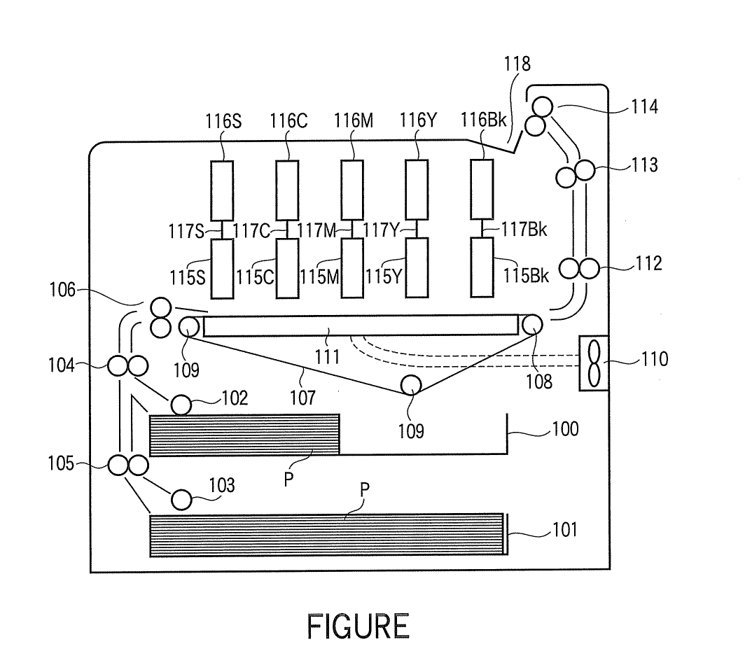

### CROSS-REFERENCE TO RELATED APPLICATIONS

This application is a Continuation of application Ser. No. 12/388,071 filed Feb. 18, 2009, which is based upon and claims the benefit of priority from U.S. Provisional Application No. 61/032,372 filed on Feb. 28, 2008, the entire contents of each of which are incorporated herein reference.

### TECHNICAL FIELD

The present invention relates to an inkjet printing method, a pretreatment liquid for inkjet printing and an ink composition.

### BACKGROUND

A conventional ink for inkjet printing generally contained water as a main component and also contained a water-soluble high-boiling point organic solvent such as glycol. The water-soluble high-boiling, point organic solvent is contained therein for the purpose of preventing drying and clogging, and the like. If such an ink was printed onto plain paper, various problems arose. Specifically, a sufficient fixability could not always be obtained. Sometimes, an uneven image was formed, which was presumably caused by uneven distribution of a filler or a sizing agent on the surface of recording paper. If an intended image was a color image, inks of a plurality of colors were superimposed on one another before they fixed to paper, therefore, it was particularly problematic. The colors were blurred or non-uniformly mixed with one another at the boundaries of images of different colors and a phenomenon called “bleeding” occurred. As a result, a satisfactory image could not be obtained.

To form a favorable color image on plain paper, a method in which plain paper is subjected to pretreatment prior to ejection of an ink is proposed. Since a pretreatment liquid is adhered to plain paper in advance, this method is called a two-liquid feeding method.

For example, JP-A-63-60783 discloses a method in which a liquid containing a basic polymer is adhered to plain paper and thereafter an ink containing an anionic dye is printed onto the plain paper. JP-A-63-22681 discloses a printing method in which a first liquid and a second liquid are mixed on plain paper. The first liquid contains a reactive chemical species, and the second liquid contains a compound which reacts with the reactive chemical species.

Further, JP-A-63-299971 discloses a method in which a liquid containing an organic compound having two or more cationic groups per molecule is adhered to plain paper and thereafter an ink containing an anionic dye is printed onto the plain paper.

JP-A-5-202328 discloses a method in which a polyvalent metal salt solution is adhered to plain paper and thereafter an ink composition containing a dye is applied to the plain paper. The dye has at least one carboxyl group and this carboxyl group reacts with a polyvalent metal ion in the polyvalent metal salt. As a result, a water-insoluble complex is formed, and therefore an image having a high quality and being excellent in water resistance without color bleeding can be obtained. Other than these, various inkjet printing methods employing a two-liquid feeding method are proposed (For example, JP-A-3-240557, JP-A-3-240558, Japanese Patent No. 3689444, Japanese Patent No. 3904120, etc.).

If any of the two-liquid feeding methods is adopted, the quality of an obtained image is favorable. However, since a printed matter resulting from an agglomeration reaction through printing by two-liquid feeding is formed on a surface layer of plain paper, a drying rate is lower than by single-liquid feeding. If a pretreatment liquid containing glycol ether as a penetrant is used, the drying rate can be increased. However, the storage stability of the pretreatment liquid is decreased by the addition of glycol ether, and as a result, the dischargeability of the pretreatment liquid becomes unstable.

### SUMMARY

An object of the present invention is to provide an inkjet printing method capable of obtaining an image of high quality by forming an inkjet printed matter excellent in quick-drying property on plain paper through a two-liquid feeding method.

Further, another object of the invention is to provide a pretreatment liquid for inkjet printing excellent in storage stability and having a good permeability through plain paper.

Still further, another object of the invention is to provide an ink composition excellent in discharge stability due to stable dispersion of a pigment and having a good permeability through plain paper.

The invention provides a method for inkjet printing comprising:

subjecting a plain paper to pretreatment by adhering a colorless pretreatment liquid containing a polyvalent metal salt, 3-methoxy-3-methyl-1-butanol, and water to the plain paper; and

forming an image by ejecting at least one type of ink composition containing a pigment and water and reacting with the polyvalent metal salt onto the plain paper subjected to the pretreatment.

Further, the invention provides a pretreatment liquid for inkjet printing which is adhered to a plain paper before an image is formed on the plain paper by ejecting an ink composition thereon with an inkjet printer, comprising 3-methoxy-3-methyl-1-butanol, a polyvalent metal salt, and water.

Still further, the invention provides an ink composition which is used in the above-mentioned method, comprising 3-methoxy-3-methyl-1-butanol.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawing, which is incorporated in and constitutes a part of the specification, illustrates embodiments of the invention, and together with the general description given above and the detailed description of the embodiments given below, serves to explain the principles of the invention.

The single FIGURE is a view showing one example of an inkjet printer according to one embodiment of the invention.

### DETAILED DESCRIPTION

Hereinafter, embodiments of the present invention will be specifically described.

The FIGURE is a cross section of a printer to be used in the inkjet printing method according to an embodiment. Paper cassettes 100 and 101 hold sheets of paper p of different sizes. A paper feed roller 102 or 103 takes out a sheet of paper p of a size corresponding to a selected paper size from the paper cassette 100 or 101 and conveys the sheet of paper to conveyor roller pairs 104 and 105 and a resist roller pair 106.

A conveyor belt 107 is tensioned by a drive roller 108 and two driven rollers 109. Holes are formed on the conveyor belt 107 at a predetermined interval, and a negative pressure chamber 111 connected to a fan 110 is provided inside the conveyor belt 107 for adsorbing the sheet of paper p onto the conveyor belt 107. Conveyor roller pairs 112, 113, and 114 are provided on the downstream in the paper conveying direction of the conveyor belt 107.

Above the upper side of the conveyor belt 107, five inkjet heads which discharge inks onto a sheet of paper according to image data are arranged in a row. Specifically, an inkjet head 115S which discharges the pretreatment liquid, an inkjet head 115C which discharges a cyan (C) ink, an inkjet head 115M which discharges a magenta (M) ink, an inkjet head 115Y which discharges a yellow (Y) ink, and an inkjet head 115Bk which discharges a black (Bk) ink are arranged in this order from the upstream. Further, the respective inkjet heads 115 are provided with a pretreatment liquid cartridge 116S which contains the pretreatment liquid, or a cyan (C) ink cartridge 116C, a magenta (M) ink cartridge 116M, a yellow (Y) ink cartridge 116Y, or a black (Bk) ink cartridge 116Bk which contains an ink of a corresponding color, and connected thereto via tubes 117S, 117C, 117M, 117Y, and 117Bk, respectively.

In the printer shown, the pretreatment liquid is applied to a desired region on the sheet of paper p using the inkjet head 115S, however, it is not limited to this configuration. The pretreatment liquid can also be applied to the entire sheet of paper using a cylindrical application roller.

The inkjet printing method according to an will be described.

First, image processing for printing is initiated by an image processing unit (not shown), and image data for printing is transferred to the respective inkjet heads 115S, 115C, 115M, 115Y, and 115Bk. Also, a sheet of paper p of a size selected by the paper feed roller 102 or 103 is taken out one by one from the paper cassette 100 or 101 and conveyed to the conveyor roller pairs 104 and 105, and the resist roller pair 106. The resist roller pair 106 corrects a skew of the sheet of paper p and conveys the sheet of paper p at a predetermined timing.

The negative pressure chamber 111 sucks air via the holes of the conveyor belt 107, therefore, the sheet of paper p is conveyed below the inkjet heads 115 while it is being adsorbed onto the conveyor belt 107. In this manner, a predetermined distance can be maintained between the respective inkjet heads 115 and the sheet of paper p. By discharging the pretreatment liquid and inks of respective colors from the respective inkjet heads 115S, 115C, 115M, 115Y, and 115Bk in synchronization with the timing when the sheet of paper p is conveyed from the resist roller pair 106, a color image is formed at a desired region on the sheet of paper p. The sheet of paper p on which an image is formed is discharged to a paper output tray 118 through conveyor roller pairs 112, 113, and 114.

According to an embodiment, the pretreatment liquid discharged from the inkjet head 115S contains a polyvalent metal salt, 3-methoxy-3-methyl-1-butanol, and water.

The polyvalent metal salt is blended in the pretreatment liquid for promoting agglomeration of pigment particles in the ink composition. Examples of the metal ion to be incorporated in the polyvalent metal salt include divalent ions such as Ca²⁺, Cu²⁺, Ni²⁺, Mg²⁺, Zn²⁺, and Ba²⁺, and trivalent ions such as Al³⁺ and Fe³⁺. Because of a high dissolution stability to water, a polyvalent metal salt containing Ca²⁺ is preferred and examples thereof include calcium chloride.

The concentration of the polyvalent metal salt in the pretreatment liquid is determined within a range in which a good printing quality is obtained and clogging is not caused. If the content of the polyvalent metal salt is too low, a desired effect cannot be sufficiently obtained. On the other hand, even if an excessive amount of the polyvalent metal salt is contained, it is not that a particularly significant effect is exhibited. The concentration of the polyvalent metal salt is preferably from about 1 to 25% by weight, and more preferably from about 2 to 15% by weight.

3-Methoxy-3-methyl-1-butanol serves as a penetrant. As the penetrant to be incorporated in the pretreatment liquid, a glycol ether solvent was generally used in the past. However, the pretreatment liquid containing a glycol ether solvent was poor in storage stability and had an insufficient permeability.

The present inventors focused their attention on the fact that 3-methoxy-3-methyl-1-butanol has a high solubility for a polyvalent metal salt. Even if a large amount (about 50% by weight) of 3-methoxy-3-methyl-1-butanol is contained in the pretreatment liquid, a polyvalent metal salt is favorably dissolved therein. Incorporation of 3-methoxy-3-methyl-1-butanol provides a pretreatment liquid having an excellent storage stability and also a favorable discharge stability and permeability.

If 3-methoxy-3-methyl-1-butanol is contained in the pretreatment liquid in an amount of 1% by weight or more, the above-mentioned effects can be obtained. Even if an excessive amount of the compound is contained, it is not that a particularly favorable effect is obtained, and therefore, the upper limit of the content thereof is preferably about 35% by weight. A more preferred content thereof is from about 3 to 20% by weight.

In addition to the above-mentioned components, an additive selected from a high-boiling point organic solvent, a pH adjusting agent, a preservative, an antifungal agent, a resin component, a surfactant, and an antifoaming agent can be blended in the pretreatment liquid as needed.

The high-boiling point organic solvent serves as an anti-drying agent, and examples of the high-boiling point organic solvent include polyhydric alcohols and nitrogen-containing heterocyclic compounds. As the polyhydric alcohol, ethylene glycol, diethylene glycol, triethylene glycol, polyethylene glycol, polypropylene glycol, 1,5-pentanediol, 1,6-hexanediol, glycerin (glycerol), 1,2,6-hexanetriol, 1,2,4-butanetriol, 1,2,3-butanetriol, petriol, or the like can be used. As the nitrogen-containing heterocyclic compound, N-methyl-2-pyrrolidone, N-hydroxyethyl-2-pyrrolidone, 2-pyrrolidone, 1,3-dimethyl imidazolidinone, ε-caprolactam, or the like can be used.

As the pH adjusting agent, for example, potassium dihydrogen phosphate, disodium hydrogen phosphate, sodium hydroxide, triethanolamine, or the like can be used.

As the preservative or antifungal agent, sodium benzoate, sodium pentachlorophenol, sodium 2-pyridinethiol-1-oxide, sodium sorbate, sodium dehydroacetate, 1,2-dibenzothiazolin-3-one (Proxel CRL, Proxel BDN, Proxel GXL, Proxel XL-2, or Proxel TN manufactured by ICI), or the like can be used.

As the resin component, for example, a cellulose, polyvinyl pyrrolidone, polyvinyl alcohol, or the like can be used.

The surfactant is not particularly limited, however, an anionic surfactant and a nonionic surfactant are preferred. Examples of the anionic surfactant include sodium dodecylbenzene sulfonate, sodium laurate, ammonium salts of polyoxyethylene alkyl ether sulfate and the like. Examples of the nonionic surfactant include polyoxyethylene alkyl ethers, polyoxyethylene alkyl esters, polyoxyethylene sorbitan fatty acid esters, polyoxyethylene alkyl phenyl ethers, polyoxyethylene alkyl amines, polyoxyethylene alkyl amides and the like.

Further, an acetylene glycol (such as Olefin Y, Surfynol 82, 104, 440, 465, and 485; all of them are manufactured by Air Products and Chemicals Inc.) may be used.

Such surfactants as described above can be used alone or in combination of two or more.

As the antifoaming agent, for example, a silicon-based antifoaming agent, an acetylene diol-based antifoaming agent, or the like can be used.

The ink composition to be ejected onto the plain paper subjected to the pretreatment contains a pigment and water. The pigment is not particularly limited, and either of an inorganic pigment and an organic pigment may be used. Examples of the inorganic pigment include titanium oxide and iron oxide. In addition, a carbon black produced by a known process such as a contact process, a furnace process or a thermal process can be used.

Examples of the organic pigment include azo pigments (including azo lake, insoluble azo pigments, condensed azo pigments, chelate azo pigments, and the like), polycyclic pigments (for example, phthalocyanine pigments, perylene pigments, perinone pigments, anthraquinone pigments, quinacridone pigments, dioxazine pigments, thioindigo pigments, isoindolinone pigments, quinophthalone pigments, and the like), dye chelates (for example, basic dye-type chelates, acid dye-type chelates, and the like), nitro pigments, nitroso pigments, and aniline black.

Specific examples of the carbon black to be used as the black ink include No. 2300, No. 900, MCF 88, No. 33, No. 40, No. 45, No. 52, MA7, MA8, MA100, No. 2200B, and the like (manufactured by Mitsubishi Chemical Corporation); Raven 5750, Raven 5250, Raven 5000, Raven 3500, Raven 1255, Raven 700, and the like (manufactured by Columbian Carbon Co., Ltd.); Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (manufactured by Cabot Corporation); and Color Black FW1, Color Black FW2, Color Black FW2V, Color Black FW18, Color Black FW200, Color Black 5150, Color Black S160, Color Black S170, Printex 35, Printex U, Printex V, Printex 140U, Special Black 6, Special Black 5, Special Black 4A, Special Black 4, and the like (manufactured by Degussa AG).

The average particle diameter of the carbon black is preferably from about 50 to 200 nm, and more preferably from about 80 to 150 nm.

The carbon black described above preferably has a carboxyl group on its surface. Such a carbon black is called a self-dispersible carbon black. A carboxyl group has a very high reactivity with a polyvalent metal ion in the pretreatment liquid. If a carboxyl group in the ink composition comes into contact with a polyvalent metal ion in the pretreatment liquid, pigment particles agglomerate very quickly. By depositing such agglomerated pigment particles on the surface of plain paper, an image of high density is obtained.

Such a carboxyl group is not necessarily present on the surface of pigment particles. Also if a polymeric dispersant having a carboxyl group in its molecular structure is contained in the ink composition, a similar effect can be obtained. Pigment particles are finely dispersed in the ink composition by a polymeric dispersant containing a carboxyl group. If such an ink composition is printed onto plain paper subjected to the pretreatment with the pretreatment liquid containing a polyvalent metal ion, pigment particles agglomerate due to a reaction between the polyvalent metal ion and the carboxyl group. As described above, by depositing the agglomerated pigment particles on the surface of plain paper, an image of high density is obtained.

Specific examples of the pigment to be used in the yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14C, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109, C.I. Pigment Yellow 110, C.I. Pigment Yellow 114, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, C.I. Pigment Yellow 185 and the like.

Specific examples of the pigment to be used in the magenta ink include C.I. Pigment Red 5, C.I. Pigment Red 7, C.I. Pigment Red 12, C.I. Pigment Red 48 (Ca), C.I. Pigment Red 48 (Mn), C.I. Pigment Red 57 (Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202, C.I. Pigment Violet 19 and the like.

Specific examples of the pigment to be used in the cyan ink include C.I. Pigment Blue 1, C.I. Pigment Blue 2, C.I. Pigment Blue 3, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Vat Blue 4, and C.I. Vat Blue 60.

Due to the same reason as in the case of the black pigment, it is preferred that also as the yellow, magenta, and cyan pigments, pigments finely dispersed by the polymeric dispersant having a carboxyl group in its molecular structure are used.

The ink composition preferably contains 3-methoxy-3-methyl-1-butanol as a penetrant. As the penetrant to be incorporated in the ink composition, a glycol ether solvent was generally used in the past. However, if a large amount of a glycol ether-based penetrant was added to a pigment ink, the dispersion stability of pigment particles over time was deteriorated, and a problem arose as to dischargeability sometimes.

Even if a large amount (about 35% by weight) of 3-methoxy-3-methyl-1-butanol is contained in the ink composition, a decrease in dispersion stability of pigment particles is less than the case of using a glycol ether-based penetrant. As a result, an ink composition having a high permeability and a favorable dischargeability over time was obtained.

If 3-methoxy-3-methyl-1-butanol is contained in the ink composition in an amount of 1% by weight or more, the above-mentioned effects can be obtained. Even if an excessive amount of the compound is contained, it is not that a particularly favorable effect is obtained, and therefore, the upper limit of the content thereof is preferably about 15% by weight.

Further, a high-boiling point organic solvent as an anti-drying agent, a pH adjusting agent, a preservative, an antifungal agent, a surfactant, or the like can be blended in the ink composition as needed. As such an additive, the same substances as those for the case of the pretreatment liquid can be used.

Since the ink composition according to an embodiment is used for inkjet printing, it is necessary that the ink composition have a viscosity appropriate for discharge from a nozzle of a head in an inkjet printer. Specifically, the ink composition preferably has a viscosity at 25° C. of 5 to 50 mPas.

In the inkjet printing method according to an embodiment, plain paper is treated with the pretreatment liquid containing 3-methoxy-3-methyl-1-butanol before an image is formed using the ink composition. As described above, the pretreatment liquid according to this embodiment has an excellent storage stability and also a favorable discharge stability and permeability.

Because the pretreatment liquid containing 3-methoxy-3-methyl-1-butanol is used, by the method according to an embodiment, an image of high quality can be formed.

If 3-methoxy-3-methyl-1-butanol is added also to the ink composition as a penetrant, the quick-drying property is further improved.

Hereinafter, Examples and Comparative examples of the invention will be described.

First, 17 types of pretreatment liquids (Pre 1 to Pre 17) were prepared. In the preparation of the respective pretreatment liquids, prescribed components were mixed according to each formulation shown below and the mixture was stirred with a stirrer for 1 hour. Thereafter, the mixture was filtered through a membrane filter with a pore size of 1 μm, whereby a desired pretreatment liquid was obtained.

Pretreatment liquid 1 (Pre 1)

| | |
|---|---|
| Calcium chloride | 0.5 wt % |
| 3-Methoxy-3-methyl-1-butanol | 5 wt % |
| Glycerin | 30 wt % |
| Emulgen 108 (polyoxyethylene lauryl ether, a surfactant | 1 wt % |
| manufactured by Kao Corporation) | |
| Proxel XL-2(s) | 0.2 wt % |
| Ion exchanged water | Balance |

Pretreatment liquid 2 (Pre 2)

| | |
|---|---|
| Calcium chloride | 1 wt % |
| 3-Methoxy-3-methyl-1-butanol | 1 wt % |
| Glycerin | 30 wt % |
| Emulgen 108 | 1 wt% |
| Proxel XL-2(s) | 0.2 wt % |
| Ion exchanged water | Balance |

Pretreatment liquid 3 (Pre 3)

| | |
|---|---|
| Calcium chloride | 2 wt % |
| 3-Methoxy-3-methyl-1-butanol | 3 wt % |
| Glycerin | 20 wt % |
| Polyethylene glycol #200 | 10 wt % |
| Emulgen 108 | 1 wt % |
| Proxel XL-2(s) | 0.2 wt % |
| Ion exchanged water | Balance |

Pretreatment liquid 4 (Pre 4)

| | |
|---|---|
| Calcium chloride | 10 wt % |
| 3-Methoxy-3-methyl-1-butanol | 5 wt % |
| Glycerin | 25 wt % |
| Emulgen 108 | 1 wt % |
| Proxel XL-2(s) | 0.2 wt % |
| Ion exchanged water | Balance |

Pretreatment liquid 5 (Pre 5)

| | |
|---|---|
| Calcium chloride | 15 wt % |
| 3-Methoxy-3-methyl-1-butanol | 10 wt % |
| Glycerin | 15 wt % |
| Polyethylene glycol #200 | 15 wt % |
| Emulgen 108 | 1 wt % |
| Proxel XL-2(s) | 0.2 wt % |
| Ion exchanged water | Balance |

Pretreatment liquid 6 (Pre 6)

| | |
|---|---|
| Calcium chloride | 10 wt % |
| 3-Methoxy-3-methyl-1-butanol | 35 wt % |
| Glycerin | 15 wt % |
| Polyethylene glycol #200 | 10 wt % |
| Emulgen 108 | 1 wt % |
| Proxel XL-2(s) | 0.2 wt % |
| Ion exchanged water | Balance |

Pretreatment liquid 7 (Pre 7)

| | |
|---|---|
| Calcium chloride | 10 wt % |
| 3-Methoxy-3-methyl-1-butanol | 20 wt % |
| Glycerin | 10 wt % |
| Polyethylene glycol #200 | 10 wt % |
| Emulgen 108 | 1 wt % |
| Proxel XL-2(s) | 0.2 wt % |
| Ion exchanged water | Balance |

Pretreatment liquid 8 (Pre 8)

| | |
|---|---|
| Calcium chloride | 25 wt % |
| 3-Methoxy-3-methyl-1-butanol | 15 wt % |
| Glycerin | 10 wt % |
| Polyethylene glycol #200 | 15 wt % |
| Emulgen 108 | 1 wt % |
| Proxel XL-2(s) | 0.2 wt % |
| Ion exchanged water | Balance |

Pretreatment liquid 9 (Pre 9)

| | |
|---|---|
| Calcium chloride | 10 wt % |
| 3-Methoxy-3-methyl-1-butanol | 40 wt % |
| Glycerin | 25 wt % |
| Emulgen 108 | 1 wt % |
| Proxel XL-2(s) | 0.2 wt % |
| Ion exchanged water | Balance |

Pretreatment liquid 10 (Pre 10)

| | |
|---|---|
| Calcium chloride | 10 wt % |
| Glycerin | 25 wt % |
| Emulgen 108 | 1 wt % |
| Proxel XL-2(s) | 0.2 wt % |
| Ion exchanged water | Balance |

Pretreatment liquid 11 (Pre 11)

| | |
|---|---|
| Calcium chloride | 5 wt % |
| Ethylene glycol monobutyl ether | 5 wt % |
| Glycerin | 25 wt % |
| Emulgen 108 | 1 wt % |
| Proxel XL-2(s) | 0.2 wt % |
| Ion exchanged water | Balance |

Pretreatment liquid 12 (Pre 12)

| | |
|---|---|
| Calcium chloride | 10 wt % |
| Diethylene glycol monobutyl ether | 5 wt % |
| Glycerin | 25 wt % |
| Emulgen 108 | 1 wt % |
| Proxel XL-2(s) | 0.2 wt % |
| Ion exchanged water | Balance |

Pretreatment liquid 13 (Pre 13)

| | |
|---|---|
| Calcium chloride | 10 wt % |
| Triethylene glycol monobutyl ether | 10 wt % |
| Glycerin | 25 wt % |
| Emulgen 108 | 1 wt % |
| Proxel XL-2(s) | 0.2 wt % |
| Ion exchanged water | Balance |

Pretreatment liquid 14 (Pre 14)

| | |
|---|---|
| Calcium chloride | 25 wt % |
| Ethylene glycol monobutyl ether | 20 wt % |
| Glycerin | 25 wt % |
| Emulgen 108 | 1 wt % |
| Proxel XL-2(s) | 0.2 wt % |
| Ion exchanged water | Balance |

Pretreatment liquid 15 (Pre 15)

| | |
|---|---|
| Calcium chloride | 30 wt % |
| Diethylene glycol monobutyl ether | 15 wt % |
| Glycerin | 25 wt % |
| Emulgen 108 | 1 wt % |
| Proxel XL-2(s) | 0.2 wt % |
| Ion exchanged water | Balance |

Pretreatment liquid 16 (Pre 16)

| | |
|---|---|
| Calcium chloride | 10 wt % |
| Ethylene glycol monobutyl ether | 1 wt % |
| Glycerin | 25 wt % |
| Emulgen 108 | 1 wt % |
| Proxel XL-2(s) | 0.2 wt % |
| Ion exchanged water | Balance |

Pretreatment liquid 17 (Pre 17)

| | |
|---|---|
| Calcium chloride | 10 wt % |
| Ethylene glycol monobutyl ether | 2 wt % |
| Glycerin | 25 wt % |
| Emulgen 108 | 1 wt % |
| Proxel XL-2(s) | 0.2 wt % |
| Ion exchanged water | Balance |

The obtained pretreatment liquids were evaluated with respect to their storage stability and dischargeability after storage.

In the evaluation of storage stability, first, 100 cc of each pretreatment liquid was taken and placed into a glass sample bottle. The bottle was tightly sealed and stored in a thermostat bath at 65° C. After 30 days, the surface tension and viscosity of each pretreatment liquid, and the deposition of precipitate therein were examined.

The surface tension was measured using a CBVP-A3 surface tensiometer (Kyowa interface Science Co., Ltd.), and the viscosity was measured using a TV-33 type viscometer (Tohki Sangyo Co., Ltd.). The physical properties such as surface tension and viscosity were evaluated by calculating percentage changes to the initial values and rating them according to the following four ratings: less than 5% (very little changed), 5% or more and less than 10% (a little changed), 10% or more and less than 20% (somewhat changed), and 20% or more (very much changed).

Further, the deposition of precipitate was visually observed. By considering all these results, the storage stability was evaluated based on the following criteria.

⊚: The change in physical properties is less than 5%, and deposition of precipitate is not observed.
◯: The change in physical properties is 5% or more and less than 10%, and deposition of precipitate is not observed.
Δ: The change in physical properties is 10% or more and less than 20%, or deposition of a little precipitate is observed.
X: The change in physical properties is 20% or more, or deposition of much precipitate is observed.

The dischargeability after storage was evaluated according to the following procedure. First, 500 cc of each pretreatment liquid was taken and placed into a glass Sample bottle. The bottle was tightly sealed and stored in a thermostat bath at 65° C. After 30 days, the dischargeability was examined using the inkjet printer equipped with a piezo head (600 dpi, manufactured by Toshiba Tec Corp.). A continuous discharge test was performed for 2 hours, and the number of times of occurrence of ink discharge failure was examined, and evaluated according to the following criteria.

⊚: Ink discharge failure did not occur. (0 times)
◯: Ink discharge failure occurred 1 to 3 times.
Δ: Ink discharge failure occurred 4 to 10 times.
X: Ink discharge failure occurred 11 times or more.

TABLE 1

| | Pretreatment liquid No. | | | | | | | | |
|---|---|---|---|---|---|---|---|---|---|
| | 1 | 2 | 3 | 4 | 5 | 6 | 7 | 8 | 9 |
| Storage stability | ⊚ | ⊚ | ⊚ | ⊚ | ⊚ | ⊚ | ⊚ | ⊚ | ◯ |
| Dischargeability | ⊚ | ⊚ | ⊚ | ⊚ | ⊚ | ⊚ | ⊚ | ⊚ | ◯ |
| after storage | | | | | | | | | |

TABLE 2

| | Pretreatment liquid No | | | | | | | |
|---|---|---|---|---|---|---|---|---|
| | 10 | 11 | 12 | 13 | 14 | 15 | 16 | 17 |
| Storage stability | ◯ | Δ | Δ | Δ | X | X | ◯ | Δ |
| Dischargeability | ◯ | Δ | ◯ | Δ | X | X | ◯ | Δ |
| after storage | | | | | | | | |

As shown in the above Table 1, the pretreatment liquids Nos. 1 to 9 containing 3-methoxy-3-methyl-1-butanol showed a favorable storage stability and dischargeability after storage.

The pretreatment liquid No. 10 does not contain 3-methoxy-3-methyl-1-butanol or a glycol ether-based penetrant, but contains glycerin instead. The pretreatment liquids Nos. 11 to 17 contain a glycol ether-based penetrant. The pretreatment liquid No. 16 in which the content of glycol ether-based penetrant is as low as 1% by weight has comparable properties to those of the pretreatment liquid No. 10. However, it is apparent from Table 2 that if the content of glycol ether-based penetrant becomes high, the storage stability and dischargeability after storage of the pretreatment liquid is decreased.

Subsequently, 11 types of ink compositions (5 types of black inks (B1 to B5), 2 types of yellow inks (Y1 and Y2), 2 types of magenta inks (M1 and M2), and 2 types of cyan inks (C1 and C2)) were prepared. In the preparation of the respective ink compositions, prescribed components were mixed according to each formulation shown below and the mixture was stirred with a stirrer for 1 hour. Thereafter, the mixture was filtered through a membrane filter with a pore size of 1 μm, whereby a desired ink composition was obtained.

Black ink 1 (B1)

| | |
|---|---|
| Carboxyl group-binding self-dispersible carbon black | 4 wt % |
| liquid (manufactured by Cabot Specialty Chemicals, | |
| Inc.) (in terms of carbon black solid content) | |
| Glycerin | 30 wt % |
| Surfynol 465 | 1 wt % |
| Proxel XL-2(s) | 0.2 wt % |
| Ion exchanged water | Balance |

Black ink 2 (B2)

| | |
|---|---|
| Carbon black liquid dispersed by carboxyl | 4 wt % |
| group-containing polymeric dispersant A | |
| (manufactured by Fuji Pigment Co., Ltd.) | |
| (in terms of carbon black solid content) | |
| 3-Methoxy-3-methyl-1-butanol | 1 wt % |
| Glycerin | 30 wt % |
| Surfynol 465 | 1 wt % |
| Proxel XL-2(s) | 0.2 wt % |
| Ion exchanged water | Balance |

Black ink 3 (B3)

| | |
|---|---|
| Carbon black liquid dispersed by carboxyl | 4 wt % |
| group-containing polymeric dispersant A | |
| (manufactured by Fuji Pigment Co., Ltd.) | |
| (in terms of carbon black solid content) | |
| 3-Methoxy-3-methyl-1-butanol | 5 wt % |
| Glycerin | 20 wt % |
| Polyethylene glycol #200 | 10 wt % |
| Surfynol 465 | 1 wt % |
| Proxel XL-2(s) | 0.2 wt% |
| Ion exchanged water | Balance |

Black ink 4 (B4)

| | |
|---|---|
| Carbon black liquid dispersed by carboxyl | 4 wt % |
| group-containing polymeric dispersant A | |
| (manufactured by Fuji Pigment Co., Ltd.) | |
| (in terms of carbon black solid content) | |
| 3-Methoxy-3-methyl-1-butanol | 10 wt % |
| Glycerin | 25 wt % |
| Surfynol 465 | 1 wt % |
| Proxel XL-2(s) | 0.2 wt % |
| Ion exchanged water | Balance |

Black ink 5 (B5)

| | |
|---|---|
| Carboxyl group-binding self-dispersible | 4 wt % |
| carbon black liquid (manufactured | |
| by Cabot Specialty Chemicals, Inc.) | |
| (in terms of carbon black solid content) | |
| 3-Methoxy-3-methyl-1-butanol | 5 wt % |
| Glycerin | 15 wt % |
| Polyethylene glycol #200 | 15 wt % |
| Surfynol 465 | 1 wt % |
| Proxel XL-2(s) | 0.2 wt % |
| Ion exchanged water | Balance |

Yellow ink 1 (Y1)

| | |
|---|---|
| Yellow pigment dispersion liquid dispersed by | 4 wt % |
| carboxy lgroup-containing polymeric dispersant A | |
| (manufactured by Fuji Pigment Co., Ltd.) | |
| (in terms of yellow pigment solid content) | |
| 3-Methoxy--3-methyl-1-butanol | 5 wt % |
| Glycerin | 20 wt % |
| Polyethylene glycol #200 | 10 wt % |
| Surfynol 465 | 1 wt % |
| Proxel XL-2(s) | 0.2 wt % |
| Ion exchanged water | Balance |

Yellow ink 2 (Y2)

| | |
|---|---|
| Yellow pigment dispersion liquid dispersed by | 4 wt % |
| carboxyl group-containing polymeric dispersant B | |
| (manufactured by Fuji Pigment Co., Ltd.) | |
| (in terms of yellow pigment solid content) | |
| 3-Methoxy-3-methyl-1-butanol | 5 wt % |
| Glycerin | 20 wt % |
| Polyethylene glycol #200 | 10 wt % |
| Surfynol 465 | 1 wt % |
| Proxel XL-2(s) | 0.2 wt % |
| Ion exchanged water | Balance |

Magenta ink 1 (M1)

| | |
|---|---|
| Magenta pigment dispersion liquid dispersed by | 4 wt % |
| carboxyl group-containing polymeric dispersant A | |
| (manufactured by Fuji Pigment Co., Ltd.) | |
| (in terms of magenta pigment solid content) | |
| 3-Methoxy-3-methyl-1-butanol | 5 wt % |
| Glycerin | 20 wt % |
| Polyethylene glycol #200 | 10 wt % |
| Surfynol 465 | 1 wt % |
| Proxel XL-2(s) | 0.2 wt % |
| Ion exchanged water | Balance |

Magenta ink 2 (M2)

| | |
|---|---|
| Magenta pigment dispersion liquid dispersed by | 4 wt % |
| carboxyl group-containing polymeric dispersant B | |
| (manufactured by Fuji Pigment Co., Ltd.) | |
| (in terms of magenta pigment solid content) | |
| 3-Methoxy-3-methyl-1-butanol | 5 wt % |
| Glycerin | 20 wt % |
| Polyethylene glycol #200 | 10 wt % |
| Surfynol 465 | 1 wt % |
| Proxel XL-2(s) | 0.2 wt % |
| Ion exchanged water | Balance |

| Cyan ink 1 (C1) | |
|---|---|
| Cyan pigment dispersion liquid dispersed by | 4 wt % |
| carboxyl group-containing polymeric dispersant A | |
| (manufactured by Fuji Pigment Co., Ltd.) | |
| (in terms of cyan pigment solid content) | |
| 3-Methoxy-3-methyl-1-butanol | 5 wt % |
| Glycerin | 20 wt % |
| Polyethylene glycol #200 | 10 wt % |
| Surfynol 465 | 1 wt % |
| Proxel XL-2(s) | 0.2 wt % |
| Ion exchanged water | Balance |

Cyan ink 2 (C2)

| | |
|---|---|
| Cyan pigment dispersion liquid dispersed by | 4 wt % |
| carboxyl group-containing polymeric dispersant B | |
| (manufactured by Fuji Pigment Co., Ltd.) | |
| (in terms of cyan pigment solid content) | |
| 3-Methoxy-3-methyl-1-butanol | 5 wt % |
| Glycerin | 20 wt % |
| Polyethylene glycol #200 | 10 wt % |
| Surfynol 465 | 1 wt % |
| Proxel XL-2(s) | 0.2 wt % |
| Ion exchanged water | Balance |

As shown in the following Table 3, printing was performed on plain paper using the pretreatment liquid and the black ink in combination, and the printing quality was evaluated. In printing, the same inkjet printer as in the case of evaluating the dischargeability of the pretreatment liquid was used. That is, an inkjet printer equipped with a piezo head (600 dpi, manufactured by Toshiba Tec Corp.) was used. As the plain paper, 5 types, i.e., Toshiba copy paper, Xerox 4024 paper, Ricoh high-grade plain paper (type E), Tidal MP paper, and Neusiedler paper were used.

TABLE 3

| | Pretreatment | Black |
|---|---|---|
| | liquid | ink |
| Example 1 | Pre 4 | B1 |
| Example 2 | Pre 4 | B2 |
| Example 3 | Pre 4 | B3 |
| Example 4 | Pre 4 | B4 |
| Example 5 | Pre 4 | B5 |
| Example 6 | Pre 1 | B3 |
| Example 7 | Pre 2 | B3 |
| Example 8 | Pre 3 | B3 |
| Example 9 | Pre 5 | B3 |
| Example 10 | Pre 6 | B3 |
| Example 11 | Pre 7 | B3 |
| Example 12 | Pre 8 | B3 |
| Comp. Ex. 1 | Pre 10 | B3 |
| Comp. Ex. 2 | Pre 16 | B3 |

The printing quality was evaluated with respect to blur, OD value, and quick-drying property.

### (Blur)

First, the pretreatment liquid was printed with 100% duty onto plain paper, and thereafter, characters were printed thereon with the black ink. After drying, whether or not blur of the characters occurred was examined and evaluated according to the following criteria. The evaluation was performed for the above-mentioned 5 types of plain paper.

OK: Blur did not occur and the characters were clear.
NG: Whisker-like blur occurred.

### (OD Value)

First, the pretreatment liquid was printed with 100% duty onto plain paper, and thereafter, a solid image was printed thereon with 100% duty using the black ink. After drying, a reflection OD of the solid image area was measured using X-Rite 900 (manufactured by X-Rite Inc.). The printing was performed on the above-mentioned 5 types of plain paper, and the OD values were obtained for the respective types of plain paper, and an average value thereof was determined to be an OD value for the respective Examples.

### (Quick-Drying Property)

Printing was performed on Toshiba copy paper as plain paper using the same inkjet printer as above.

First, the pretreatment liquid was printed with 100% duty onto a 10 mm×10 mm area of plain paper, and thereafter, a solid image was printed thereon with 100% duty using the black ink. After the plain paper was left as such for a predetermined time, a sheet of unprinted plain paper of the same type was superimposed on the printed area, and 300 g of a weight was placed thereon. After 10 seconds, the superimposed unprinted plain paper was peeled away, and whether or not the ink adhered thereto was examined.

The time until the unprinted plain paper was superimposed after the solid image was formed was set to be 4 types, that is, 5 sec, 10 sec, 30 sec, and 60 sec. The degree of adherence of ink was visually examined for each time and evaluated according to the following criteria.

⊚: Ink did not adhere to the paper when the above-mentioned time was 5 sec.
◯: Ink did not adhere to the paper when the above-mentioned time was 10 sec.
Δ: Ink did not adhere to the paper when the above-mentioned time was 30 sec.
X: Ink adhered to the paper when the above-mentioned time was 60 sec.

The obtained results for Examples 1 to 12, and Comparative examples 1 and 2 are summarized in the following Table 4.

TABLE 4

| | | | Quick-drying |
|---|---|---|---|
| | Blur | OD value | property |
| Example 1 | OK | 1.45 | ◯ |
| Example 2 | OK | 1.43 | ◯ |
| Example 3 | OK | 1.41 | ⊚ |
| Example 4 | OK | 1.38 | ⊚ |
| Example 5 | OK | 1.43 | ⊚ |
| Example 6 | OK | 1.28 | ⊚ |
| Example 7 | OK | 1.31 | ◯ |
| Example 8 | OK | 1.35 | ⊚ |
| Example 9 | OK | 1.43 | ⊚ |
| Example 10 | OK | 1.40 | ⊚ |
| Example 11 | OK | 1.42 | ⊚ |
| Example 12 | OK | 1.48 | ⊚ |
| Comp. Ex. 1 | OK | 1.48 | X |
| Comp. Ex. 2 | OK | 1.42 | Δ |

In Examples 1 to 12, two-liquid type printing was performed using the pretreatment liquid containing 3-methoxy-3-methyl-1-butanol as a penetrant. In each Example, an image excellent in quick-drying property and having a high density and a high quality was obtained.

In Comparative examples 1 and 2 in which the pretreatment liquid free from 3-methoxy-3-methyl-1-butanol was used, the quick-drying property was poor.

Particularly, in Examples 2 to 12, because 3-methoxy-3-methyl-1-butanol was also contained in the ink composition, the quick-drying property was further improved.

Subsequently, printing was performed on plain paper using the black ink, color inks and pretreatment liquid in combination as shown in the following Table 5, and the printing quality was evaluated.

TABLE 5

| | Pretreatment | Black | Color |
|---|---|---|---|
| | liquid | ink | inks |
| Example 13 | Pre 4 | B3 | Y1M1C1 |
| Example 14 | Pre 4 | B3 | Y2M2C2 |
| Comp. Ex. 3 | Non | B3 | Y2M2C2 |
| Comp. Ex. 4 | Non | B3 | Y1M1C1 |

The occurrence of blur, OD value, and quick-drying property were evaluated according to the above-mentioned procedures. Further, color bleeding was examined. Specifically, first, the pretreatment liquid was printed with 100% duty onto each of the above-mentioned 5 types of plain paper using the above-mentioned inkjet printer. Thereafter, the color inks (yellow, magenta, and cyan) and the black ink (characters) were simultaneously printed thereon with 100% duty, and the degree of uneven color mixing at a boundary region of characters was examined and evaluated according to the following criteria.

OK: Color bleeding did not occur and the boundary was clear.
NG: Whisker-like color bleeding occurred.

The results are summarized in the following Table 6.

TABLE 6

| | | | Quick-drying | Color |
|---|---|---|---|---|
| | Blur | OD value | property | bleeding |
| Example 13 | OK | 1.41 | ⊚ | OK |
| Example 14 | OK | 1.41 | ⊚ | OK |
| Comp. Ex. 3 | NG | 1.21 | ◯ | NG |
| Comp. Ex. 4 | NG | 1.21 | ◯ | NG |

In Comparative example 3, printing was performed under the same condition as in Example 13 except that the pretreatment using the pretreatment liquid containing 3-methoxy-3-methyl-1-butanol was not performed. In Comparative example 4, printing was performed under the same condition as in Example 14 except that the pretreatment using the pretreatment liquid containing 3-methoxy-3-methyl-1-butanol was not performed. In each of Examples 13 and 14, and Comparative examples 3 and 4, the used ink compositions contained 3-methoxy-3-methyl-1-butanol.

As shown by the results of Comparative examples 3 and 4, if the pretreatment using the pretreatment liquid containing 3-methoxy-3-methyl-1-butanol was not performed, blur occurred. Further, the quick-drying property was poor, therefore, in the Comparative examples, color bleeding could not be avoided.

In the inkjet printing method according to an embodiment, an inkjet printed matter excellent in quick-drying property is formed on plain paper, and an image of high quality can be obtained by the two-liquid feeding method.

Further, the pretreatment liquid according to an embodiment is excellent in storage stability and having a good permeability through plain paper.

Further, the ink composition according to an embodiment is excellent in discharge stability due to stable dispersion of pigment particles and having a good permeability through plain paper.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An inkjet printer comprising:
a first inkjet head which discharges a pretreatment liquid to subject plain paper to pretreatment, the pretreatment liquid comprising 3-methoxy-3-methyl-1-butanol, a polyvalent metal salt, and water;
a first cartridge containing the pretreatment liquid;
a second inkjet head which discharges an ink composition onto subject plain paper subjected to the pretreatment, the ink composition comprising 3-methoxy-3-methyl-1-butanol and a pigment; and
a second cartridge containing the ink composition.

2. The inkjet printer according to claim 1, wherein the pretreatment liquid comprises 3-methoxy-3-methyl-1-butanol at a concentration of 1 to 35% by weight.

3. The inkjet printer according to claim 2, wherein the pretreatment liquid comprises 3-methoxy-3-methyl-1-butanol at a concentration of 3 to 20% by weight.

4. The inkjet printer according to claim 1, wherein the polyvalent metal salt in the pretreatment liquid comprises a metal ion selected from the group consisting of Ca²⁺, Cu²⁺, Ni²⁺, Mg²⁺, Zn²⁺, Ba²⁺, Al³⁺, and Fe³⁺.

5. The inkjet printer according to claim 1, wherein the polyvalent metal salt is calcium chloride.

6. The inkjet printer according to claim 1, wherein the pretreatment liquid comprises the polyvalent metal salt at a concentration of 1 to 25% by weight.

7. The inkjet printer according to claim 6, wherein the pretreatment liquid comprises the polyvalent metal salt at a concentration of 2 to 15% by weight.

8. The inkjet printer according to claim 1, wherein the pretreatment liquid further comprises at least one selected from the group consisting of a high-boiling point organic solvent, a pH adjusting agent, a preservative, an antifungal agent, a resin component, a surfactant, and an antifoaming agent.

9. The inkjet printer according to claim 1, wherein the ink composition comprises 3-methoxy-3-methyl-1-butanol at a concentration of 1 to 15% by weight.

10. The inkjet printer according to claim 1, wherein the pigment in the ink composition is a carbon black having a carboxyl group on its surface.

11. The inkjet printer according to claim 1, wherein the ink composition further comprises a carboxyl group-containing polymeric dispersant for dispersing the pigment.

12. The inkjet printer according to claim 1, wherein the pigment in the ink composition comprises particles having an average particle diameter of 50 to 200 nm.

13. The inkjet printer according to claim 1, wherein the ink composition further comprises at least one selected from the group consisting of a high-boiling point organic solvent, a pH adjusting agent, a preservative, an antifungal agent, and a surfactant.

14. The inkjet printer according to claim 1, wherein the ink composition has a viscosity at 25° C. of 5 to 50 mPas.

15. A method for inkjet printing comprising:
subjecting a plain paper to pretreatment by adhering a colorless pretreatment liquid containing a polyvalent metal salt, 3-methoxy-3-methyl-1-butanol, and water to the plain paper; and
forming an image by ejecting at least one type of ink composition containing a pigment and water and reacting with the polyvalent metal salt onto the plain paper subjected to the pretreatment.

16. The method according to claim 15, wherein the image is formed using one type of ink composition.

17. The method according to claim 16, wherein the ink composition is selected from the group consisting of a black ink, a cyan ink, a magenta ink, and a yellow ink.

18. The method according to claim 15, wherein the image is formed using two or more types of ink compositions.

19. The method according to claim 18, wherein the ink compositions are selected from the group consisting of a black ink, a cyan ink, a magenta ink, and a yellow ink.
